(19) United States
(12) Patent Application Publication
(10) Pub. No.: US 2021/0258887 A1
(43) Pub. Date: Aug. 19, 2021

(54) USER EQUIPMENT

(71) Applicant: NTT DOCOMO, INC., Tokyo (JP)

(72) Inventors: Ryosuke Osawa, Chiyoda-ku, Tokyo (JP); Yuichi Kakishima, Chiyoda-ku, Tokyo (JP); Kazuaki Takeda, Chiyoda-ku, Tokyo (JP)

(73) Assignee: NTT DOCOMO, INC., Tokyo (JP)

(21) Appl. No.: 17/255,743

(22) PCT Filed: Jul. 3, 2018
(86) PCT No.: PCT/JP2018/025273

§ 371 Date: Dec. 23, 2020

(51) Int. Cl. H04W 52/24; H04W 52/36; H04W 76/14; H04W 76/40

(52) U.S. Cl. CPC H04W 52/242; H04W 76/40; H04W 76/14; H04W 52/367

(57) ABSTRACT

A user equipment for performing inter-terminal direct communication with one or a plurality of user equipments, includes a receiving unit configured to receive a synchronization signal or a reference signal transmitted from the plurality of user equipments; a control unit configured to control transmission power of the inter-terminal direct communication, based on the received synchronization signal or the received reference signal transmitted from the plurality of user equipments; and a transmitting unit configured to perform transmission of the inter-terminal direct communication by applying the controlled transmission power, to at least one of the plurality of user equipments.

### TECHNICAL FIELD

The present invention relates to a user equipment in a radio communication system.

### BACKGROUND ART

In LTE (Long Term Evolution) and successor systems of LTE (for example, LTE-A (LTE Advanced) and NR (New Radio) (also referred to as 5G)), a D2D (Device to Device) technology in which user equipments directly communicate with each other without involving a radio base station, is being studied (for example, Non-Patent Literature 1).

D2D reduces the traffic between the user equipment and the base station apparatus, and enables communication between the user equipments even when the base station apparatus becomes unable to communicate in the event of a disaster, etc. Note that in 3GPP (3rd Generation Partnership Project), D2D is referred to as “sidelink”; however, in the present specification, D2D, which is a more general term, is used. However, sideline is also used as necessary in the description of the embodiment to be described later.

D2D is generally classified into D2D discovery (also referred to as D2D detection) for discovering other communicable user equipments and D2D communication (also referred to as D2D direct communication, inter-terminal direct communication, etc.) for user equipments to directly communicate with each other. In the following description, when D2D communication, D2D discovery, etc., are not particularly distinguished, these may be simply referred to as D2D. Furthermore, signals used for transmission and reception in D2D are referred to as D2D signals. Various use cases of services related to V2X (Vehicle to Everything) in 5G are being studied (for example, Non-Patent Literature 2).

### CITATION LIST

### Non-Patent Literature

[NPTL 1] 3GPP TS 36.211 V15.1.0 (2018 March)

[NPTL 2] 3GPP TR 22.836 V15.1.0 (2017 March)

### SUMMARY OF INVENTION

### Technical Problem

In D2D communication assuming V2X, unicasting, multicasting, or broadcasting is being studied. In the case of multicasting or broadcasting, a plurality of terminals is the transmission targets, and, therefore, it has been difficult to perform appropriate transmission power control.

The present invention has been made in view of the above points, and it is an object of the present invention to perform appropriate transmission power control in inter-terminal direct communication.

### Solution to Problem

According to the disclosed technology, there is provided a user equipment for performing inter-terminal direct communication with one or a plurality of user equipments, the user equipment including a receiving unit configured to receive a synchronization signal or a reference signal transmitted from the plurality of user equipments; a control unit configured to control transmission power of the inter-terminal direct communication, based on the received synchronization signal or the received reference signal transmitted from the plurality of user equipments; and a transmitting unit configured to perform transmission of the inter-terminal direct communication by applying the controlled transmission power, to at least one of the plurality of user equipments.

### Advantageous Effects of Invention

According to the disclosed technology, appropriate transmission power control can be performed in inter-terminal direct communication.

### BRIEF DESCRIPTION OF DRAWINGS

FIG. 1 is a diagram for describing V2X.

FIG. 2 is a diagram for describing an example of an operation of a radio communication system according to an embodiment of the present invention.

FIG. 3 is a flowchart for describing transmission power control (1) according to the embodiment of the present invention.

FIG. 4 is a flowchart for describing transmission power control (2) according to the embodiment of the present invention.

FIG. 5 is a diagram illustrating an example of a functional configuration of a base station apparatus 10 according to an embodiment of the present invention.

FIG. 6 is a diagram illustrating an example of a functional configuration of a user equipment 20 according to an embodiment of the present invention.

FIG. 7 is a diagram illustrating an example of a hardware configuration of the base station apparatus 10 or the user equipment 20 according to an embodiment of the present invention.

### DESCRIPTION OF EMBODIMENT

Hereinafter, an embodiment of the present invention will be described with reference to the drawings. Note that the embodiment described below is merely an example, and embodiments to which the present invention is applied are not limited to the following embodiment.

In the operation of the radio communication system according to an embodiment of the present invention, the existing technology is appropriately used. The existing technology is, for example, existing LTE; however, the existing technology is not limited to existing LTE. Furthermore, the term “LTE” used in the present specification shall have a broad meaning including LTE-Advanced and methods after LTE-Advanced (e.g., NR) unless otherwise specified.

Furthermore, in the present embodiment, the duplex method may be the TDD (Time Division Duplex) method, the FDD (Frequency Division Duplex) method, or other methods (for example, the Flexible Duplex method).

Furthermore, in the following description, the method of transmitting signals by using transmission beams, may be digital beamforming for transmitting signals multiplied by precoding vectors (precoded with precoding vectors), or may be analog beamforming for realizing beamforming by using a variable phase shifter in an RF (Radio Frequency) circuit. Similarly, the method of receiving signals by using reception beams, may be digital beamforming for multiplying received signals by a predetermined weight vector, or analog beamforming for realizing beamforming by using a variable phase shifter in an RF circuit. Hybrid beamforming, in which digital beamforming and analog beamforming are combined, may be applied. Also, transmitting signals by using transmission beams, may be to transmit signals at a particular antenna port. Similarly, receiving signals by using reception beams may be to receive signals at a particular antenna port. An antenna port refers to a logical antenna port or a physical antenna port defined in the 3GPP standard.

Note that the method of forming a transmission beam and a reception beam is not limited to the above method. For example, in a base station apparatus 10 or a user equipment 20 having a plurality of antennas, a method of changing the angle of each antenna may be used, or a method using a combination of a method of using a preceding vector and a method of changing the angle of the antenna may be used, a method of switching between different antenna panels may be used, a method of combining a plurality of antenna panels may be used, or another method may be used. Furthermore, for example, in the high frequency band, a plurality of mutually different transmission beams may be used. Using a plurality of transmission beams is referred to as a multi-beam operation, and using one transmission beam is referred to as a single beam operation.

Furthermore, in the embodiment of the present invention, the radio parameter, etc., being “configured” means that a predetermined value is “pre-configured”, or a radio parameter, which is reported from the base station apparatus 10 or a user equipment 20, is configured.

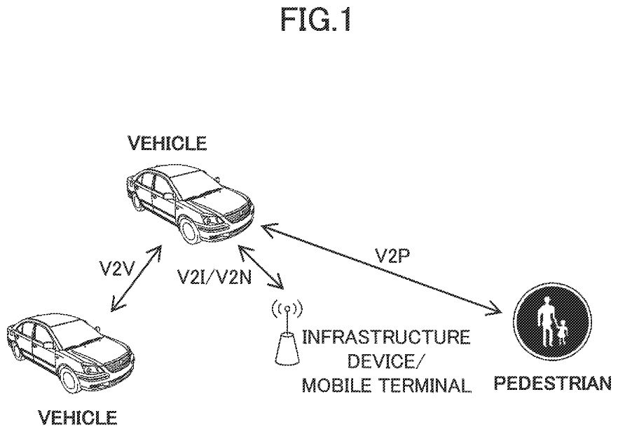

FIG. 1 is a diagram for describing V2X. In 3GPP, studies are being made to realize V2X (Vehicle to Everything) or eV2X (enhanced V2X) by extending the D2D function, and specifications of V2X are being made. As illustrated in FIG. 1, V2X is a part of ITS (Intelligent Transport Systems), and V2X is a collective term of V2V (Vehicle to Vehicle) meaning a communication mode implemented between vehicles, V2I (Vehicle to Infrastructure) meaning a communication mode implemented between a vehicle and a road-side unit (RSU) installed at the side of a road, V2N (Vehicle to Nomadic device) meaning a communication mode implemented between a vehicle and a mobile terminal held by a driver), and V2P (Vehicle to Pedestrian) meaning a communication mode implemented between a vehicle and a mobile terminal of a pedestrian

In the embodiments of the present invention, a mode in which a communication apparatus is installed in a vehicle is mainly assumed; however, the embodiment of the present invention is not limited to such a mode. For example, the communication apparatus may be a terminal held by a person, or the communication apparatus may be an apparatus installed in a drone or an aircraft, or the communication apparatus may be a base station, an RSU, or a relay station, etc.

Furthermore, in Rel-14 of LTE, specifications related to some functions of V2X are being made. In these specifications, Mode 3 and Mode 4 are defined with respect to resource allocation for V2X communication to the user equipment 20. In Mode 3, a transmission resource is dynamically allocated by DCI (Downlink Control Information) transmitted from the base station apparatus 10 to the user equipment 20. Furthermore, in Mode 3, SPS (Semi Persistent Scheduling) is also possible. In Mode 4, the user equipment 20 autonomously selects a transmission resource from the resource pool.

Furthermore, in 3GPP, V2X using cellular communication and inter-terminal communication of LTE or NR is being studied. For V2X of LTE or NR, it is assumed that studies not limited to The 3GPP specification, will be advanced. For example, it is assumed that securing interoperability, increasing the cost efficiency by implementing an upper layer, a method of using a plurality of RATs (Radio Access Technology) in combination or a method of switching the RATs, addressing regulations in each country, acquiring and distributing data of a V2X platform of LTE or NR, and managing and using a database, will be studied.

SL (Sidelink) may be distinguished based on either UL (Uplink) or DL (Downlink) or one of or a combination of the following 1)-4). Furthermore, the SL may be another name.

1) Resource in time domain
2) Resource in the frequency domain
3) Synchronization signals to be referred to
4) Reference signals used for SL transmission power control

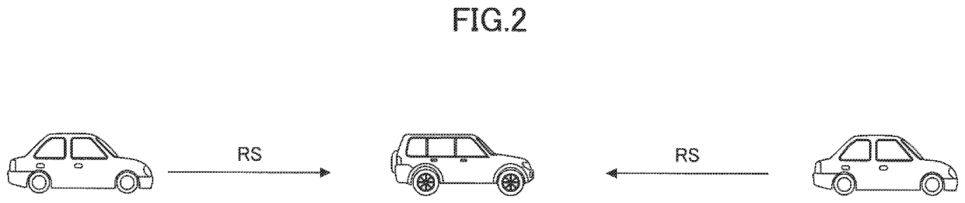

FIG. 2 is a diagram for describing an example of the operation of the radio communication system according to the embodiment of the present invention. For example, in the transmission of PUSCH (Physical Uplink Shared Channel) of NR, it is possible to configure a plurality of parameter sets {P_{0_PUSCH, f, c,} α_{f, c}} used for transmission power control and a plurality of reference signals for path loss calculation. The base station apparatus 10 configures a combination of a parameter used for transmission power control and a reference signal for path loss calculation, in the user equipment 20 by RRC (Radio Resource Control) signaling. P_{0_PUSCH, f, c} is a parameter specifying the nominal electric power of PUSCH. α_{f, c} is a parameter that defines a value that can be configured in the UL transmission power control, in the carrier f of a serving cell c. The reference signal for the path loss calculation is, for example, SS (Synchronization signal), and CSI-RS (Channel state information-reference signal). Similar parameters are configured for the transmission of PUCCH (Physical Uplink Control Channel) and SRS (Sounding Reference Signal).

Furthermore, for example, in the SL (Sidelink) of LTE, a plurality of parameter sets {P_{0_PSSCH}/P_{0_PSCCH}, α_{PSSCH}/α_{PSCCH}} used for transmission power control cannot be configured, and one parameter set {P_{0_PSSCH}/P_{0_PSCCH}, α_{PSSCH}/α_{PSCCH}} is used for the transmission power control of PSSCH (Physical Sidelink Shared Channel) or PSCCH (Physical Sidelink Control Channel). For the path loss calculation, a DL reference signal is used; not an SL reference signal.

On the other hand, QoS (Quality of Service) control is being studied in SL of NR, and path loss compensation using SL reference signals may be adopted.

In SL, unicasting, multicasting, or broadcasting is studied as a transmission format, and in multicasting or broadcasting, a plurality of terminals are the transmission targets. Therefore, when an SL reference signal is used in the SL transmission power control, if path loss calculation is performed based on an SL reference signal transmitted by a particular terminal, there is a possibility that the transmission power cannot be appropriately controlled.

Furthermore, as illustrated in FIG. 2, a plurality of SL reference signals may be received from a plurality of terminals, and, therefore, it has not been clear as to which SL reference signal is to be used for transmission power control.

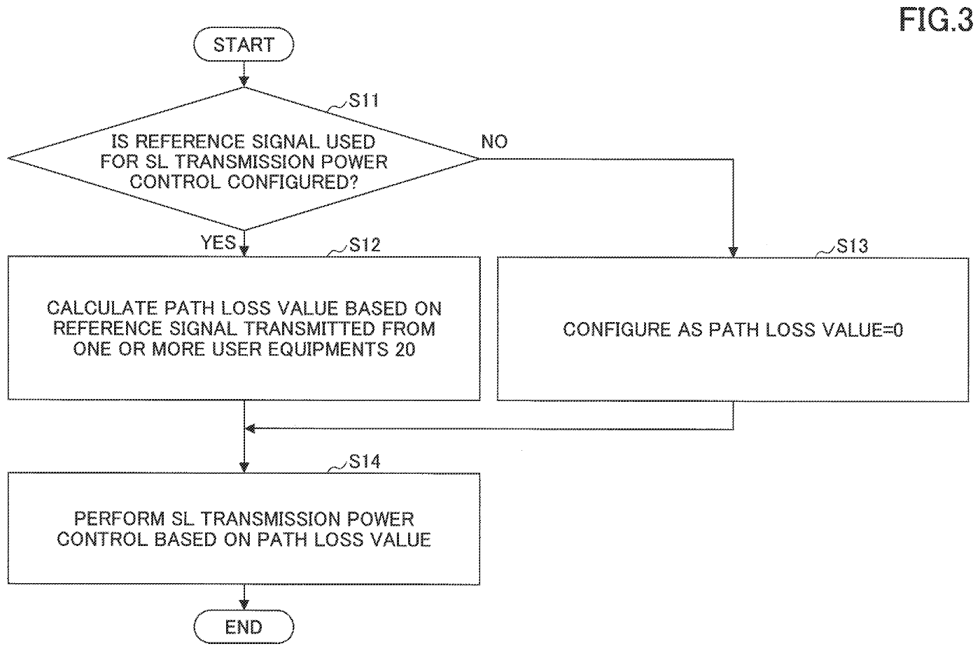

FIG. 3 is a flowchart for describing the transmission power control (1) according to the embodiment of the present invention. Referring to FIG. 3, a procedure for determining a path loss value based on a reference signal or a synchronization signal transmitted from a plurality of terminals will be described. The reference signal may be referred to as, for example, SLSS (Sidelink Synchronization Signal), SL-CSI-RS (Sidelink-channel state information-reference signal), SL-SRS (Sidelink-sounding reference signal), or DMRS (Demodulation reference signal), etc. Furthermore, the parameter (for example, {P_{0_PSSCH}/P_{0_PSCCH}, α_{PSSCH}/α_{PSCCH}}) and/or the reference signal may be configured for each cell and/or carrier (for example, a carrier component, a frequency/time resource, BWP (Bandwidth part)) and/or user equipment.

In step S11, the user equipment 20 determines whether a reference signal used for SL transmission power control is configured. When a reference signal used for SL transmission power control is configured, the process proceeds to step S12 (YES in step S11). When a reference signal used for SL transmission power control is not configured, the process proceeds to step S13 (NO in step S11). The base station apparatus 10 or another user equipment 20 may configure a reference signal used for SL transmission power control in the user equipment 20, or a reference signal used for SL transmission power control may be defined in advance. The configuring of a reference signal used for SL transmission power control may be instructed from the base station apparatus 10 by layer signaling of any one of a PHY (Physical) layer, a MAC (Media Access Control) layer, and an RRC (Radio Resource Control) layer, via a DL signal of any one of or a combination of PBCH (Physical Broadcast Channel), PDCCH (Physical Downlink Control Channel), and PDSCH (Physical Downlink Shared Channel). Furthermore, the configuring of a reference signal used for SL transmission power control may be instructed from another user equipment 20 by layer signaling of any one of a PHY layer, a MAC layer, and an RRC layer, via an SL signal of any one of or a combination of PSBCH (Physical Sidelink Broadcast Channel), PSCCH (Physical Sidelink Control Channel), and PSSCH (Physical Sidelink Shared Channel).

In step S12, the user equipment 20 calculates the path loss value based on the reference signal transmitted from one or a plurality of user equipments 20. When calculating the path loss value based on a reference signal transmitted from one user equipment 20, the information indicating the reference signal to be referred to (for example, information indicating a resource of the reference signal and/or the user equipment 20), may be reported or instructed by the base station apparatus 10 or another user equipment 20, or may be defined in the specification. When calculating the path loss value based on the reference signals transmitted from the plurality of user equipments 20, after calculating the path loss value for each user equipment 20 based on the measurement result of the reference signal configured in step S11, the path loss value used for SL transmission power control may be a value obtained by averaging the path loss values of a plurality of user equipments 20 upon converting the path loss values into linear values, or may be a value obtained by averaging the path loss values with logarithmic notations. Furthermore, the path loss value used for the SL transmission power control may be an average value of the top N number of path loss values of the plurality of user equipments 20, or an average value of the bottom N number of path loss values of the plurality of user equipments 20. The value of N may be configured by the base station apparatus 10 or another user equipment 20. Furthermore, the path loss value used for SL transmission power control may be the maximum value or the minimum value of the path loss values of the plurality of user equipments 20. Note that the path loss value may be calculated upon adding the base station apparatus 10 to the plurality of user equipments 20.

In the step of calculating the path loss value for each of the user equipments 20 in the above step S12, a path loss value may be calculated for each resource of the reference signals or for each sequence of the reference signals, instead of for each user equipment 20.

Note that other quality indicators may be calculated, similarly to the calculation of the path loss in step S12. That is, a reference signal used in a quality indicator may be configured, the quality indicators of the plurality of user equipments 20 may be calculated, and the average value, the maximum value, or the minimum value may be used as the quality indicator. The quality indicator is, for example, RSRP (Reference Signal Received Power), RSRQ (Reference Signal Received Quality), SNR (Signal-to-noise ratio), and RSSI (Received Signal Strength Indicator), etc. When the quality indicators of a plurality of user equipments 20 are calculated and the average value, the maximum value, or the minimum value is used as the quality indicator, this value may be referred to as a “group quality indicator”. For example, if RSRP is the group quality indicator, the value may be referred to as Group-RSRP. The user equipment 20 may transmit a report (Measurement report) to the base station apparatus 10 according to a request (Measurement report request) from the base station apparatus 10.

Note that the reference signal used for SL transmission power control is not limited to SLSS, SL-RS, or DMRS. As the reference signal used for the SL transmission power control, other signals may be used, such as a PTRS (Phase tracking reference signal), and a position measurement signal, etc.

In step S13, the user equipment 20 configures the path loss value to 0, without configuring a reference signal used for SL transmission power control. The signaling of the RRC layer may be NULL, in the case where the base station apparatus 10 or another user equipment 20 configures a reference signal used for SL transmission power control in the user equipment 20, thereby reporting that a reference signal used for SL transmission power control will not be configured. The parameter set {P_{0_PSSCH}/P_{0_PSCCH}, α_{PSSCH}/α_{PSCCH}}, which is used for SL transmission power control in the case where a reference signal used for SL transmission power control is not configured, may be separately configured from {P_{0_PSSCH}/P_{0_PSCCH}, α_{PSSCH}/α_{PSCCH}} in the case where a reference signal used for SL transmission power control is configured.

In step S14, the user equipment 20 performs SL transmission power control based on the path loss value. The user equipment 20 executes SL transmission to which SL transmission power control has been applied, to at least one user equipment 20 among the plurality of user equipments 20 that have measured the reference signal. For SL transmission power control, closed loop control by a TPC (Transmit power control) command may be applied. The closed loop may be associated with the reference signal, similar to the case of UL of NR.

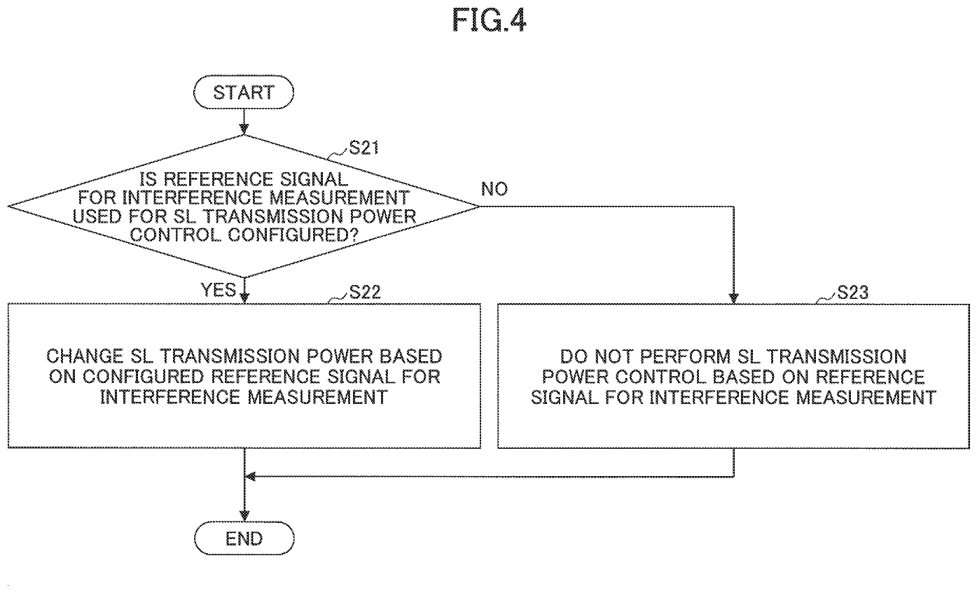

FIG. 4 is a flowchart for describing the transmission power control (2) according to the embodiment of the present invention. In FIG. 4, a method of monitoring the interference from a neighboring cell or user equipment 20, and performing SL transmission power control according to the interference value, will be described.

In step S21, the user equipment 20 determines whether an interference measurement reference signal used for the SL transmission power control is configured. The interference measurement reference signal may be replaced with a gap. When an interference measurement reference signal used for the SL transmission power control is configured, the process proceeds to step S22 (YES in S21), and when an interference measurement reference signal used for SL transmission power control is not configured, the process proceeds to step S23 (NO in S21), and the user equipment 20 ends the flow without performing SL transmission power control based on an interference measurement reference signal.

An interference measurement reference signal used for the SL transmission power control may be instructed from the base station apparatus 10 by layer signaling of any one of a PHY layer, a MAC layer, and an RRC layer, via a DL signal of any one of or a combination of PBCH, PDCCH, and PDSCH. Furthermore, an interference measurement reference signal used for the SL transmission power control may be instructed from another user equipment 20 by layer signaling of any one of a PHY layer, a MAC layer, and an RRC layer, via an SL signal of any one of or a combination of PSBCH, PSCCH, and PSSCH.

In step S22, the SL transmission power is changed based on the configured interference measurement reference signal. The interference measurement reference signal used for the SL transmission power control and the method of measuring the interference may be specified as 1), 2), or 3) below.

1) A reference signal (non-zero power CSI-RS) of another cell, another resource, or another resource pool is specified, and the reception power of the reference signal is taken as the interference value.
2) A reference signal of the own cell, the own resource, or the own resource pool is specified, and a value, which is obtained by subtracting the power value of the reception signal estimated from a channel estimation value and a reference signal sequence from the reception power of the reference signal, is taken as the interference value.
3) A gap is specified in the own cell, the own resource, or the own resource pool, and the power of other cell, the other resource, or the other resource pool in the gap is measured and taken as the interference value.

According to the method of 1), 2), or 3), the user equipment 20 reduces the SL transmission power in accordance with the calculated interference value. Note that a threshold value of the interference value may be configured, or may be defined in advance. When the calculated interference value exceeds the threshold value of the interference value, the SL transmission power is reduced by a predetermined value. A plurality of threshold values of the interference value may be configured, and the reduction value of the SL transmission power may be determined for each of the threshold values.

The threshold value of the interference value may be instructed from the base station apparatus 10 by layer signaling of any one of a PHY layer, a MAC layer, and an RRC layer, via a DL signal of any one of or a combination of PBCH, PDCCH, and PDSCH. Furthermore, the threshold value of the interference value may be instructed from another user equipment 20 by layer signaling of any one of a PHY layer, a MAC layer, and an RRC layer, via an SL signal of any one of or a combination of PSBCH, PSCCH, and PSSCH.

The method of reducing the SL transmission power may be a method executed by changing one or more values of MPR (Maximum power reduction), P_{0_PSSCH}/P_{0_PSCCH}, α_{PSSCH}/α_{PSCCH}, or a path loss value. Information, which indicates which one of the MPR, P_{0_PSSCH}/P_{0_PSCCH}, α_{PSSCH}/α_{PSCCH}, and the path loss value is to be used to execute the reduction of the SL transmission power, may be instructed from the base station apparatus 10 by layer signaling of any one of a PHY layer, a MAC layer, and an RRC layer, via a DL signal of any one of or a combination of PBCH, PDCCH, and PDSCH, or may be instructed from another user equipment 20 by layer signaling of any one of a PHY layer, a MAC layer, and an RRC layer, via an SL signal of any one of or a combination of PSBCH, PSCCH, and PSSCH.

The reduction of the SL transmission power may be executed spontaneously by the user equipment 20, based on the reference signal for measuring the surrounding interference, the measurement method and threshold value of the interference value, and the method of reducing the SL transmission power configured as described above, or may be executed based on a report or an instruction from the base station apparatus 10 or another user equipment 20.

The user equipment 20 may amplify the SL transmission power based on the reference signal for measuring the surrounding interference and the measurement method and threshold value of the interference value, instead of the above method of reducing the SL transmission power. The amplification of the SL transmission power may be ramped as in PRACH (Physical Random Access Channel) transmission. The information indicating the amplification value for each ramping operation may be reported or instructed from the base station apparatus 10 by layer signaling of any one of a PHY layer, a MAC layer, and an RRC layer, via a DL signal of any one of or a combination of PBCH, PDCCH, and PDSCH, or may be reported or instructed from another user equipment 20 by layer signaling of any one of a PHY layer, a MAC layer, and an RRC layer, via an SL signal of any one of or a combination of PSBCH, PSCCH, and PSSCH. When performing repetitive transmission of TTI (Transmission Time Interval) bundling, the user equipment 20 may ramp the SL transmission power for each TTI bundling operation, or may ramp the SL transmission power at the time of HARQ re-transmission, or may ramp the SL transmission power for each slot or each TTI.

According to the embodiment described above, even when the side link communication is multicasting or broadcasting, the user equipment 20 can execute appropriate SL transmission power control by measuring the reference signal transmitted from a plurality of user equipments 20.

That is, in inter-terminal direct communication, appropriate transmission power control can be performed.

### Apparatus Configuration

Next, a functional configuration example of the base station apparatus 10 and the user equipment 20 that execute the above-described processes and operations, will be described. The base station apparatus 10 and the user equipment 20 include functions for implementing the above-described embodiments. However, each of the base station apparatus 10 and the user equipment 20 may have only some of the functions of the embodiments.

### Base Station Apparatus 10

FIG. 5 is a diagram illustrating an example of a functional configuration of the base station apparatus 10. As illustrated in FIG. 5, the base station apparatus 10 includes a transmitting unit 110, a receiving unit 120, a configuring unit 130, and a control unit 140. The functional configuration illustrated in FIG. 5 is only an example. As long as the operations according to the embodiment of the present invention can be executed, the functional division and the name of the functional unit may be any functional division and name.

The transmitting unit 110 includes a function of generating signals to be transmitted to the user equipment 20, and transmitting the signals in a wireless manner. The receiving unit 120 includes a function of receiving various signals transmitted from the user equipment 20, and acquiring, for example, information of a higher layer from the received signals. Furthermore, the transmitting unit 110 has a function of transmitting NR-PSS, NR-SSS, NR-PBCH, and DL/UL control signals, etc., to the user equipment 20. Furthermore, for example, the transmitting unit 110 transmits information indicating that another terminal is approaching the user equipment 20, and the receiving unit 120 receives the terminal information from the user equipment 20.

The configuring unit 130 stores pre-configured configuration information and various kinds of configuration information to be transmitted to the user equipment 20, in a storage device, and reads these pieces of information from the storage device as necessary. The content of the configuration information is, for example, information related to transmission power control of D2D communication.

As described in the embodiment, the control unit 140 performs processing related to configurations for performing D2D communication by the user equipment 20. Furthermore, the control unit 140 performs a process of reporting information related to transmission power control, to the user equipment 20. A functional unit related to signal transmission in the control unit 140, may be included in the transmitting unit 110, and a functional unit related to signal reception in the control unit 140, may be included in the receiving unit 120.

### User Equipment 20

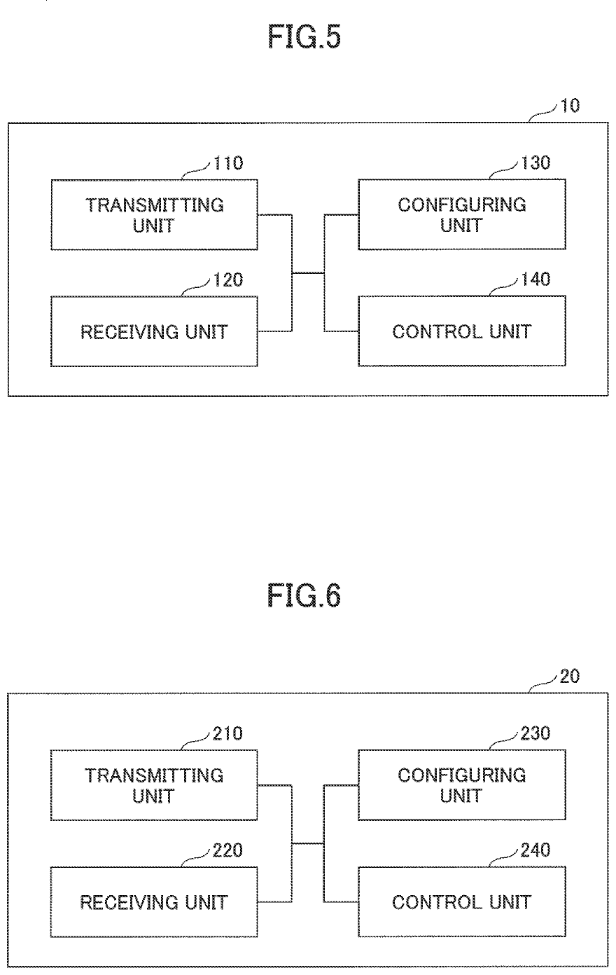

FIG. 6 is a diagram illustrating an example of a functional configuration of the user equipment 20. As illustrated in FIG. 6, the user equipment 20 includes a transmitting unit 210, a receiving unit 220, a configuring unit 230, and a control unit 240. The functional configuration illustrated in FIG. 6 is only an example. As long as the operations according to the embodiment of the present invention can be executed, the functional division and the name of the functional unit may be any functional division and name.

The transmitting unit 210 creates transmission signals from the transmission data and wirelessly transmits the transmission signals. The receiving unit 220 wirelessly receives various kinds of signals and acquires signals of a higher layer from the received signals of the physical layer. Furthermore, the receiving unit 220 has a function of receiving NR-PSS, NR-SSS, NR-PBCH, and DL/UL/SL control signals, etc., transmitted from the base station apparatus 10. Furthermore, for example, the transmitting unit 210 may transmit as D2D communication, to another user equipment 20, PSCCH (Physical Sidelink Control Channel), PSSCH (Physical Sidelink Shared Channel), PSDCH (Physical Sidelink Discovery Channel), and PSBCH (Physical Sidelink Broadcast Channel), etc., and the receiving unit 120 may receive, from another user equipment 20, PSCCH, PSSCH, PSDCH, or PSBCH, etc.

The configuring unit 230 stores various kinds of configuration information received from the base station apparatus 10 or the user equipment 20, by the receiving unit 220, in a storage device, and reads these pieces of information from the storage device as necessary. Furthermore, the configuring unit 230 also stores pre-configured configuration information. The content of the configuration information is, for example, information related to transmission power control of D2D communication.

As described in the embodiment, the control unit 240 controls the D2D communication executed with another user equipment 20. Furthermore, the control unit 240 performs transmission power control of the D2D communication based on a path loss value or interference power. A functional unit related to signal transmission in the control unit 240 may be included in the transmission unit 210, and a functional unit related to signal reception in the control unit 240 may be included in the reception unit 220.

### Hardware Configuration

The functional diagrams (FIGS. 5 and 6) used in the description of the above embodiment of the present invention illustrate blocks of functional units. These functional blocks (constituent parts) are implemented by any combination of hardware and/or software. Furthermore, the means for implementing each functional block is not particularly limited. That is, the respective functional blocks may be implemented by a single device in which a plurality of elements are physically and/or logically combined; or two or more devices, which are physically and/or logically separated, may be directly and/or indirectly (for example, wired and/or wireless) connected, and the respective functional blocks may be implemented by these plural devices.

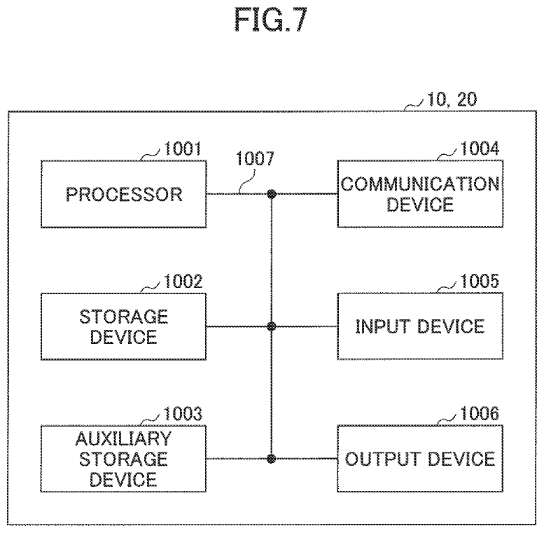

Furthermore, for example, both the base station apparatus 10 and the user equipment 20 according to one embodiment of the present invention may function as a computer that performs processes according to an embodiment of the present invention. FIG. 7 is a diagram illustrating an example of a hardware configuration of a radio communication apparatus that is the base station apparatus 10 or the user equipment 20 according to an embodiment of the present invention. Each of the base station apparatus 10 and the user equipment 20 described above may be physically configured as a computer device including a processor 1001, a storage device 1002, an auxiliary storage device 1003, a communication device 1004, an input device 1005, an output device 1006, and a bus 1007, etc.

Note that in the following description, the term “device” can be read as a circuit, a device, and a unit, etc. The hardware configuration of the base station apparatus 10 and the user equipment 20 may be configured to include one or a plurality of devices indicated by the reference numerals 1001 to 1006 illustrated in the drawing, or may be configured to not include some of the devices.

The respective functions of the base station apparatus 10 and the user equipment 20 are implemented by having predetermined software (programs) to be loaded in the hardware such as the processor 1001 and the storage device 1002 so that the processor 1001 performs computation and controls the communication performed by the communication device 1004 and the reading and/or writing of data in the storage device 1002 and the auxiliary storage device 1003.

The processor 1001, for example, operates the operating system to control the entire computer. The processor 1001 may be configured with a Central Processing Unit (CPU) including an interface with peripheral devices, a control device, an arithmetic device, and a register, etc.

Furthermore, the processor 1001 loads programs (program codes), software modules, or data from the auxiliary storage device 1003 and/or the communication device 1004 into the storage device 1002, and executes various processes according to these elements. As the program, a program for causing a computer to execute at least part of the operation described in the above embodiment, is used. For example, the transmitting unit 110, the receiving unit 120, the configuring unit 130, and the control unit 140 of the base station apparatus 10 illustrated in FIG. 5 may be implemented by a control program that is stored in the storage device 1002 and that operates on the processor 1001. Furthermore, for example, the transmitting unit 210, the receiving unit 220, the configuring unit 230, and the control unit 240 of the user equipment 20 illustrated in FIG. 6 may be implemented by a control program that is stored in the storage device 1002 and that operates on the processor 1001. Although it has been described that the various processes described above are executed by a single processor 1001, the various processes described above may be executed simultaneously or sequentially by two or more processors 1001. The processor 1001 may be implemented by one or more chips. Note that the programs may be transmitted from the network via an electric communication line.

The storage device 1002 is a computer-readable recording medium, and is configured with at least one of a ROM (Read-Only Memory), an EPROM (Erasable Programmable ROM), an EEPROM (Electrically Erasable Programmable ROM), and a RAM (Random Access Memory), for example. The storage device 1002 may be referred to as a register, a cache, and a main memory (main memory), etc. The storage device 1002 can store executable programs (program codes) and software modules, etc., for implementing the processes according to an embodiment of the present invention.

The auxiliary storage device 1003 is a computer-readable recording medium, and may be configured with at least one of, for example, an optical disk such as a CD-ROM (Compact Disc ROM), a hard disk drive, a flexible disk, a magneto-optical disk (for example, a compact disk, a digital versatile disk, a Blu-ray (Registered trademark) disk), a smart card, a flash memory (for example, a card, a stick, a key drive), a floppy (registered trademark) disk, and a magnetic strip, etc. The auxiliary storage device 1003 may be referred to as an auxiliary storage device. The above-described storage medium may be, for example, a database including the storage device 1002 and/or the auxiliary storage device 1003, a server, or other appropriate media.

The communication device 1004 is hardware (transmission/reception device) for performing communication between computers via a wired and/or wireless network, and is also referred to as a network device, a network controller, a network card, and a communication module, etc., for example. For example, the transmitting unit 110 and the receiving unit 120 of the base station apparatus 10 may be implemented by the communication device 1004. Furthermore, the transmitting unit 210 and the receiving unit 220 of the user equipment 20 may be implemented by the communication device 1004.

The input device 1005 is an input device (for example, a keyboard, a mouse, a microphone, a switch, a button, and a sensor, etc.) that accepts input of information from the outside. The output device 1006 is an output device (for example, a display, a speaker, and an LED lamp, etc.) that outputs information to the outside. Note that the input device 1005 and the output device 1006 may be integrated (for example, a touch panel).

Furthermore, the respective devices such as the processor 1001 and the storage device 1002 are connected by the bus 1007 for communicating information. The bus 1007 may be configured with a single bus or may be configured with different buses between the respective devices.

Furthermore, each of the base station apparatus 10 or the user equipment 20 may include hardware such as a microprocessor, a digital signal processor (DSP), an application specific integrated circuit (ASIC), a programmable logic device (PLD), and a field programmable gate array (FPGA), and some of or all of the functional blocks may be implemented by this hardware. For example, the processor 1001 may be implemented with at least one of these hardware elements.

### Overview of Embodiment

As described above, according to the embodiment of the present invention, there is provided a user equipment for performing inter-terminal direct communication with one or a plurality of user equipments, the user equipment including

a receiving unit configured to receive a synchronization signal or a reference signal transmitted from the plurality of user equipments;

a control unit configured to control transmission power of the inter-terminal direct communication, based on the received synchronization signal or the received reference signal transmitted from the plurality of user equipments; and

a transmitting unit configured to perform transmission of the inter-terminal direct communication by applying the controlled transmission power, to at least one of the plurality of user equipments.

With the above configuration, even when the sidelink communication is multicasting or broadcasting, the user equipment 20 can execute appropriate SL transmission power control by measuring the reference signals transmitted from a plurality of user equipments 20. That is, in inter-terminal direct communication, appropriate transmission power control can be performed.

The synchronization signal or the reference signal used for measurement for controlling the transmission power of the inter-terminal direct communication, may be configured by a base station apparatus or a user equipment, or may be defined in advance. With this configuration, the user equipment 20 can execute appropriate SL transmission power control by measuring the reference signals transmitted from a plurality of user equipments 20.

The control unit may calculate a path loss value for each of the plurality of user equipments, based on the received synchronization signal or the received reference signal transmitted from the plurality of user equipments, and may control the transmission power of the inter-terminal direct communication, based on an average path loss value, a maximum path loss value, or a minimum path loss value, among the path loss values of the plurality of user equipments. With this configuration, the user equipment 20 can execute the appropriate SL transmission power control by measuring the reference signals transmitted from a plurality of user equipments 20 and calculating a path loss value.

The control unit may control the transmission power of the inter-terminal direct communication, based on the path loss value set as zero, in a case where the synchronization signal or the reference signal used for the measurement for controlling the transmission power of the inter-terminal direct communication, is not configured by a base station apparatus or a user equipment. With this configuration, by setting the path loss value to 0, the user equipment 20 can prevent the SL transmission from being executed with excessive transmission power, and can reduce interference.

A parameter related to the controlling of the transmission power, in a case where the synchronization signal or the reference signal used for the measurement for controlling the transmission power of the inter-terminal direct communication is configured by a base station apparatus or a user equipment, and a parameter related to the controlling of the transmission power, in a case where the synchronization signal or the reference signal used for the measurement for controlling the transmission power of the inter-terminal direct communication is not configured by a base station apparatus or a user equipment, may be separately configured. With this configuration, the user equipment 20 separately configures a parameter for performing the SL transmission power control based on the path loss value and a parameter for performing the SL transmission power control based on the path loss value set to zero, so that the user equipment 20 can execute appropriate SL transmission power control according to the configuration.

A reference signal used for measurement of surrounding interference for controlling the transmission power of the inter-terminal direct communication, may be configured by a base station apparatus or a user equipment, or is defined in advance. With this configuration, the user equipment 20 can execute measurement of the surrounding interference and execute the SL transmission power control in which the interference with respect to the surroundings is suppressed.

### Supplement to Embodiment

The exemplary embodiment of the present invention is described above, but the disclosed invention is not limited to the above embodiment, and those skilled in the art would understand that various modified examples, revised examples, alternative examples, substitution examples, and the like can be made. In order to facilitate understanding of the present invention, specific numerical value examples are used for description, but the numerical values ate merely examples, and certain suitable values may be used unless otherwise stated. The classification of items in the above description is not essential to the present invention, matters described in two or more items may be combined and used as necessary, and a matter described in one item may be applied to a matter described in another item (unless there is no contradiction). The boundary between functional units or processing units in a functional block diagram does not necessarily correspond to the boundary between physical parts. Operations of a plurality of functional units may be performed physically by one component, or an operation of one functional unit may be performed physically by a plurality of parts. In the processing procedures described in the embodiment, the order of processes may be changed as long as there is no inconsistency. For the sake of convenience of description, the base station apparatus 10 and the user equipment 20 have been described using the functional block diagrams, but such apparatuses may be implemented by hardware, software, or a combination thereof. Software executed by the processor included in the base station apparatus 10 according to the embodiment of the present invention, and the software executed by the processor of the user equipment 20 according to the embodiment of the present invention, may be stored in a random access memory (RAM), a flash memory, a read only memory (ROM), an EPROM, an EEPROM, a register, a hard disk (HDD), a removable disk, a CD-ROM, a database, a server, or any other appropriate storage medium.

Furthermore, notification of information is not limited to the aspect/embodiment described in the present specification, and may be performed by other methods. For example, the notification of information may be performed by physical layer signaling (for example, DCI (Downlink Control Information), UCI (Uplink Control Information)), upper layer signaling (for example, RRC (Radio Resource Control) signaling, MAC (Medium Access Control) signaling, broadcast information (MIB (Master Information Block), SIB (System Information Block)), other signals, or a combination of these methods. Furthermore, the RRC signaling may be referred to as an RRC message, and may be, for example, an RRC Connection Setup message or an RRC Connection Reconfiguration message, etc.

Each aspect/embodiment described in the present specification may be applied to LTE (Long Term Evolution), LTE-A (LTE-Advanced), SUPER 3G, IMT-Advanced, 4G, 5G, FRA (Future Radio Access), W-CDMA (registered trademark), GSM, (registered trademark), CDMA2000, UMB (Ultra Mobile Broadband), IEEE 302.11 (Wi-Fi), IEEE 802.16 (WiMAX), IEEE 802.20, UWB (Ultra-WideBand), Bluetooth (registered trademark), and a system using other appropriate systems and/or a next generation system expanded based on these systems.

In the processes, sequences, and flowcharts, etc., in each aspect/embodiment described in the present specification, the order of processes may be exchanged, as long as there is no inconsistency. For example, for the methods described in the present specification, elements of the various steps are presented in an exemplary order and are not limited to the presented specific order.

The specific operation that is performed by the base station apparatus 10 in the present specification may be performed by an upper node of the base station apparatus 10 in some cases. It is obvious that in a network including one or more network nodes including the base station apparatus 10, various operations performed for communication with the user equipment 20, may be performed by the base station apparatus 10 and/or a network node of other than the base station apparatus 10 (for example, MME or S-GW, etc., although not limited as such). In the above example, there is one network node other than the base station apparatus 10; however, a combination of a plurality of other network nodes (for example, MME and S-GW) may be used.

Each aspect/embodiment described in the present specification may be used singly or in combination, or may be switched in accordance with execution.

The user equipment 20 may be referred to, by those skilled in the art, as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable term.

The base station apparatus 10 may be referred to, by those skilled in the art, as a NB (Node B), an eNB (evolved Node B), gNB, a Base Station, or some other suitable term.

The terms “determining” and “deciding” used in the present specification may encompass a wide variety of operations. “Determining” and “deciding” may include the meaning of, for example, judging, calculating, calculating, computing, processing, deriving, investigating, looking up (for example, searching a table, a database, or another data structure), and ascertaining, etc. Furthermore, “determining” and “deciding” may include the meaning of receiving (for example, receiving information), transmitting (for example, transmitting information), inputting, outputting, and accessing (for example, accessing data in a memory). Furthermore, “determining” and “deciding” may include the meaning of resolving, selecting, choosing, establishing, and comparing, etc. In other words, “determining” and “deciding” include the meaning of “determining” and “deciding” some kind of operation.

The phrase “based on” used in the present specification does not mean “based only on”, unless explicitly stated otherwise. In other words, the phrase “based on” means both “based only on” and “based on at least”.

The terms “include”, “including”, and variations thereof used in the present specification or claims, are intended to be inclusive in a manner similar to the term “comprising”. Furthermore, the term “or” used in the present specification or claims, is not intended to be exclusive OR.

In the entire present disclosure, if articles are added by translation, such as a, an, and the in English, for example, these articles may include a plural number of items/units, unless it is indicated that these articles are obviously not plural from the context.

Note that in the embodiments of the present invention, the parameter set {P_{0_PSSCH}/P_{0_PSCCH}, α_{PSSCH}/α_{PSCCH}} is an example of a parameter related to transmission power control.

Although the present invention has been described in detail above, it will be obvious to those skilled in the art that the present invention is not limited to the embodiments described herein. The present invention can be implemented as modifications and variations without departing from the spirit and scope of the present invention as defined by the scope of the claims. Therefore, the description of the present specification is for the purpose of illustration and does not have any restrictive meaning to the present invention.

### Reference Signs List

10 base station apparatus
110 transmitting unit
120 receiving unit
130 configuring unit
140 control unit
20 user equipment
210 transmitting unit
220 receiving unit
230 configuring unit
240 control unit
1001 processor
1002 storage device
1003 auxiliary storage device
1004 communication device
1005 input device
1006 output device

1. A user equipment for performing inter-terminal direct communication with one or a plurality of user equipments, the user equipment comprising:
a receiving unit configured to receive a synchronization signal or a reference signal transmitted from the plurality of user equipments;
a control unit configured to control transmission power of the inter-terminal direct communication, based on the received synchronization signal or the received reference signal transmitted from the plurality of user equipments; and
a transmitting unit configured to perform transmission of the inter-terminal direct communication by applying the controlled transmission power, to at least one of the plurality of user equipments.

2. The user equipment according to claim 1, wherein the synchronization signal or the reference signal used for measurement for controlling the transmission power of the inter-terminal direct communication, is configured by a base station apparatus or a user equipment, or is defined in advance.

3. The user equipment according to claim 1, wherein
the control unit calculates a path loss value for each of the plurality of user equipments, based on the received synchronization signal or the received reference signal transmitted from the plurality of user equipments, and
controls the transmission power of the inter-terminal direct communication, based on an average path loss value, a maximum path loss value, or a minimum path loss value, among the path loss values of the plurality of user equipments.

4. The user equipment according to claim 2, wherein
the control unit controls the transmission power of the inter-terminal direct communication, based on the path loss value set as zero, in a case where the synchronization signal or the reference signal used for the measurement for controlling the transmission power of the inter-terminal direct communication, is not configured by a base station apparatus or a user equipment.

5. The user equipment according to claim 2, wherein
a parameter related to the controlling of the transmission power, in a case where the synchronization signal or the reference signal used for the measurement for controlling the transmission power of the inter-terminal direct communication is configured by a base station apparatus or a user equipment, and
a parameter related to the controlling of the transmission power, in a case where the synchronization signal or the reference signal used for the measurement for controlling the transmission power of the inter-terminal direct communication is not configured by a base station apparatus or a user equipment,
are separately configured.

6. The user equipment according to claim 1, wherein a reference signal used for measurement of surrounding interference for controlling the transmission power of the inter-terminal direct communication, is configured by a base station apparatus or a user equipment, or is defined in advance.
